(19) United States
(12) Patent Application Publication
(10) Pub. No.: US 2003/0017013 A1
(43) Pub. Date: Jan. 23, 2003

(54) Hobbing cutter

(76) Inventors: Wolfgang Soltau, Neu Darchau (DE); Klaus Oppelt, Lauenburg (DE); Wolfgang Carmincke, Scharnebeck (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/197,182

(22) Filed: Jul. 17, 2002

(30) Foreign Application Priority Data
Jul. 19, 2001 (DE) 101 35 282.4

(51) Int. Cl. B26D 1/12

(52) U.S. Cl. 407/30

(57) ABSTRACT

A hobbing cutter, comprising a tool body which is at least partially formed from a cutting material and has a through axial bore, bore portions at the ends of the axial bore, a shank body at either end of the tool body which has a portion adapted to be inserted into the bore portion so as to approximately fit therein, a radial flange adapted to abut on the front-end face of the tool body when the portion is seated in the bore portion as well as a shank portion on the side of the flange opposing the portion which is to be mounted in a machine tool wherein the shank bodies have an axial bore each containing a female-threaded portion which are in an opposed sense, and a clamping bar which is adapted to be inserted into and passed through the axial bores of the tool body and the shank bodies and the ends of which have a male-threaded portion each which interengages the associated female-threaded portion in such a way that if the threads are relatively rotated in a predetermined sense of rotation the shank bodies are drawn into the tool body and are tightened towards each other.

### CROSS-REFERENCES TO RELATED APPLICATIONS

Not Applicable.

### STATEMENT REGARDING FEDERALLY SPONSORED RESEARCH

Not Applicable.

### BACKGROUND OF THE INVENTION

As is known, hobbing cutters first and foremost are used for manufacturing toothed components such as gears, worn gears, racks and the like. For hobbing cutters, a general distinction is made, with respect to their seating in a hobbing machine, between a bore-type design and a shank-type design. In the bore-type design, the through axial bore of the tool body is provided with a longitudinal groove for a positive torque transmission. As an alternative, a one-sided or two-sided transverse groove may be provided at the front-end faces of the tool body for a positive torque transmission. However, a bore design using frictional transmission at the front-end face is known as well. Hobbing cutters of the bore-type design are used, first and foremost, for series production and lower requirements to workpiece precision. Usually, hobbing cutters are formed from high-speed steel. However, it is also known to manufacture the hobbing cutter from sintered hard carbide.

In the shank-type design, shanks are formed at the ends of the tool body for a non-positive torque transmission. The shanks may be tapered on the two sides or tapered on one side or may be cylindrical on one side or the two sides. The shanks may be hollow and the tapered shanks may also be designed as steep-angle tapers. Hobbing cutters of the shank-type design are primarily used for high requirements to quality, which presupposes a high truth of running. The disadvantage, however, is that their manufacture involves relative high expenditure, specifically if the tool body is made from sintered carbide. Milling cutters made of sintered carbide are extremely sensitive to shocks and bumps. If the cutter is damaged it frequently requires replacement.

DE 198 60 403 has made known an assembly composed of a hobbing cutter and a mounting mandrel in which the tool body is provided with an axial bore the ends of which have ground cylindrical centering surfaces. The mandrel extending through the bore has complementary seating surfaces. The space between the centering and seating surfaces has disposed therein a sleeve-shaped cage which is of a thickness which is smaller than the radial distance between the centering and seating surfaces, and of an outer diameter which is smaller than the inner diameter of the centering surfaces. In a circumferential direction, at least one series of preferably metallic biasing members are supported in the cage and are in a contact with the associated seating surface and the seating surface. The diameter and the distance between the bearing points or bearing lines of the biasing members is slightly larger than the radial distance of the centering and seating surfaces. At one end, the mandrel has a threaded portion onto which a hydraulically acting clamping nut can be screwed which acts on a front-end face of the cutter body via a ring while a collar of the mounting mandrels bears on the other front-end face of the tool body at the opposed end. The tool body is axially located on the mandrel in this way. In place of the sleeve-shaped cages, a clamping sleeve may be provided which is radially expandable hydraulically and acts between the centering and seating surfaces. The assembly described is intended to allow a high truth of running with no need to accept the disadvantages of a shank-type design. Nevertheless, the assembly described involves relatively great expenditure.

It is the object of the invention to provide a hobbing cutter which has the truth in running of a shank-type design hobbing cutter and can be accommodated to various mounting conditions.

### BRIEF SUMMARY OF THE INVENTION

In the inventive hobbing cutter, the tool body provided with an axial bore has bore portions at the ends. Separate shank bodies are provided for both ends of the tool body. Each shank body has a portion adapted to be appropriately mounted in the bore portion. It further has a radial flange which abuts on the outer surface of the tool body when the portion comes to be seated in the bore portion. The surfaces of the bore and the shank bodies help in obtaining a precise centering of the tool body and, thus, the high truth in running that is desired. The portions of the shank bodies may be tapered, cylindrical, or polygonal in cross-section and the bore portions in the tool body are formed accordingly. The other side of the flange has provided thereon a shank portion which is to be chucked in the machine tool with this portion being cylindrical or even tapered at choice.

The shank bodies have axial through bores and the bores have female-threaded portions with each pair of shank bodies having opposite-sense female-threaded portions. Finally, a clamping member is provided, e.g. a clamping rod or clamping bar, which has male-threaded portions in the end areas. These are brought into engagement with the female-threaded portions. This allows to clamp the shank bodies in and against the tool body. For this purpose, the interengaging pairs of threads are in opposite senses in order to produce the clamping action described.

According to an aspect of the invention, the clamping bar is completely received within the tool body and the shank bodies and is provided with an internal hexagon at one end for engagement by a screwing tool. The flange may have at least one radial groove which is aligned with a radial groove on the axial collar of the tool body for a positive torque transmission from the mounting in the hobbing machine to the hobbing cutter.

The inventive design of a hobbing cutter equals a hobbing cutter of a shank-type design with no need to form the shank integrally with the tool body. Rather, the clamping shanks may be exchanged, e.g. against other ones having another possible mounting such as a tapered mounting. In other words, the tool bodies may be manufactured as a standard whatever the tool mounting might be whereas appropriate clamping shanks for the machine mounting concerned are connected to the tool bodies. The inventive hobbing cutter may also allow to exchange the drive end. If the shanks are no longer usable because of damage or wear they may be readily substituted for by intact shanks. Also, it is readily possible to employ specialty shanks, which are adapted to the manufacturing machine, for the manufacture of the hobbing cutter.

In the inventive hobbing cutter, the through bore of the tool body allows to obtain a reduction in weight and material. This specifically is true for tool bodies in sintered carbide. The shank bodies are preferably manufactured from steel. Apart from the aforementioned advantages in manufacture and mounting, the advantage of a high truth of running is obtained as is achieved in conventional shank-type designs.

### BRIEF DESCRIPTION OF THE SEVERAL VIEWS OF THE DRAWINGS

The invention will be explained in greater detail below with reference to an embodiment shown in the drawings.

FIG. 1 shows a partial section through a hobbing cutter according to the invention.

FIG. 2 shows the view of the hobbing cutter of FIG. 1 in the direction of arrow 2.

FIG. 3 shows a side view of the clamping bar of the hobbing cutter of FIG. 1.

### DETAILED DESCRIPTION OF THE INVENTION

While this invention may be embodied in many different forms, there are described in detail herein a specific preferred embodment of the invention. This description is an exemplification of the principles of the invention and is not intended to limit the invention to the particular embodiment illustrated.

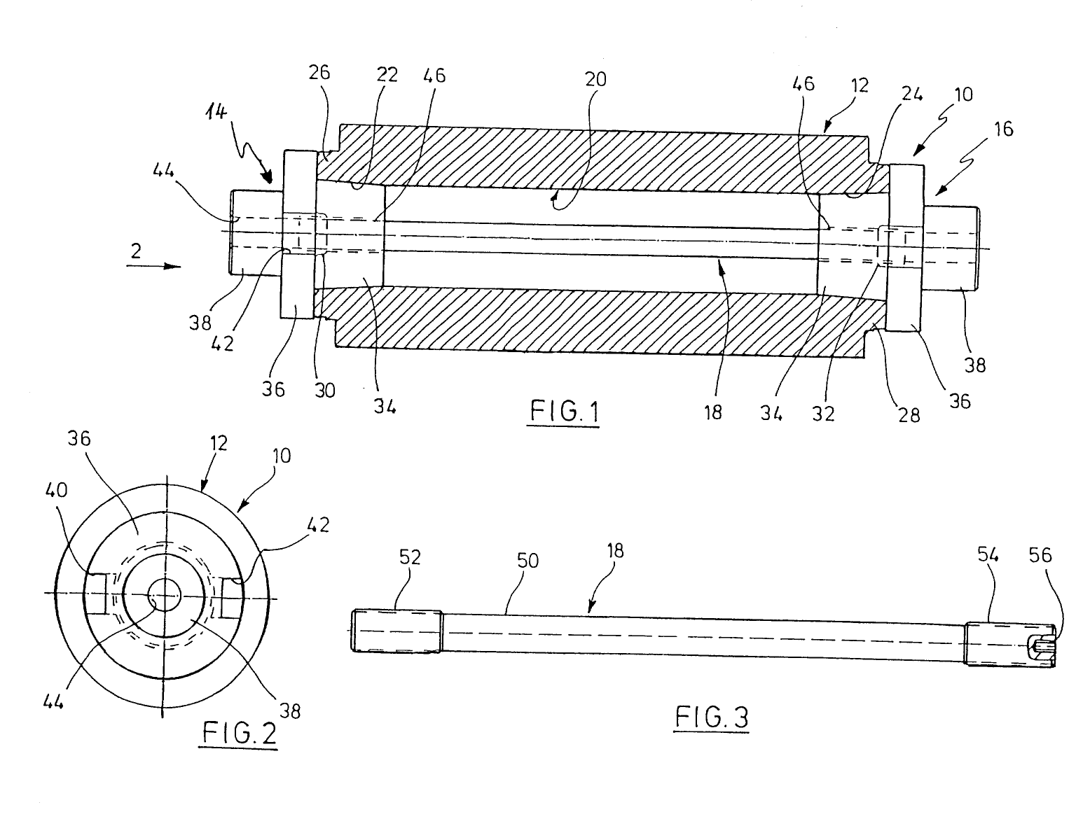

Referring to FIGS. 1 and 2, a hobbing cutter 10 is shown which is composed of a tool body 12, shank bodies 14, 16, and a clamping bar 18.

The tool body 12, which is integrally manufactured from sintered carbide, for example, has a shape as is common for hobbing cutters. No detailed reference will be made to this fact. The tool body 12 has an axial through bore 20 which has tapered bore portions 22 and 24 at the ends. The extension of the tapered bore portions 22 and 24 is towards the ends of the bore 20. The ends of the tool body 12 each have an axial collar 26 and 28 in which radial grooves shown in phantom lines are diametrically formed at 30 and 32 in FIG. 1.

Each shank body 14, 16 has a tapered portion 34, a radial flange 36, and a clamping portion 38. The latter are cylindrical. However, they may also be tapered. The tapered portions 34 are fittingly seated in the bore portions 22, 24 of the tool body 12. The surfaces of the bore portions 22, 24 are precision-ground. This is also true for the conical surfaces of the tapered portions 34. When the tapered portions 34 are seated in the bore portions the flange 36 will closely engage the pertinent axial collar 26, 28.

As will be appreciated from FIG. 2 the flange 36 has radial, diametrically opposed grooves 40, 42 which are aligned with the grooves 30, 32 of the tool body 12. The grooves serve for a positive fit with the mounting of the hobbing machine for a torque transmission from the spindle of the machine to the hobbing cutter 10.

The shank bodies 14, 16 have a through bore 44 which is provided with a female thread 46 in the area of the tapered portion 34.

The clamping bar illustrated in FIG. 3 has a relatively long, smooth bar portion 50 the ends of which are provided with male-threaded portions 52 and 54 the diameter of which is slightly larger than that of the bar portion 50. The free end of the threaded portion 54 has provided thereon an internal hexagon 56 for engagement by a tool to turn it. The threads of the male-threaded portions 52, 54 are in an opposed sense and so are the threads 46 of the tapered portions 34. After assembly, if the clamping bar 18 is rotated, e.g. in a clockwise sense, it will clamp the shank bodies 14, 16 against each other so that the tapered portions 34 come to closely engage the tapered bore portions 22, 24 to center the tool body 12 with respect to the shank bodies 14, 16. The flanges 36 help in axially locating the tool body 12. As was mentioned before torque transmission is performed via the grooves 30, 32 of the tool body 12. The flanges also prevent the tapered portions to be drawn too far into the bore 20, which can cause the tool body to burst.

The above Examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

What is claimed is:

1. A hobbing cutter, comprising:
a tool body (12) which is at least partially formed from a cutting material and has a through axial bore (20);
bore portions (22, 24) at the ends of the axial bore (20);
a shank body (14, 16) at either end of the tool body (12) which has a portion (34) adapted to be inserted into the bore portion (22, 24) so as to approximately fit therein;
a radial flange (36) adapted to abut on the front-end face of the tool body (12) when the portion (34) is seated in the bore portion (22, 24), as well as
a shank portion (38) on the side of the flange (36) opposing the portion (34) which is to be mounted in a machine tool wherein the shank bodies (14, 16) have an axial bore (44) each containing a female-threaded portion (46) which are in an opposed sense, and
a clamping member, preferably a clamping bar (18), which is adapted to be inserted into and passed through the axial bores (20) of the tool body (12) and the shank bodies (14, 16) and the ends of which have a male-threaded portion (52, 54) each which engages the associated female-threaded portion (46) in such a way that if the threads are relatively rotated in a predetermined sense of rotation the shank bodies (14, 16) are drawn into the tool body (12) and are tightened towards each other.

2. The hobbing cutter according to claim 1, characterized in that the clamping bar (18) has an internal hexagon (56) at one end.

3. The hobbing cutter according to claim 1, characterized in that the female-threaded portions (46) are disposed at a distance from the outer end of the axial bore (44) and the male-threaded portions (52, 54) are disposed at the ends of the clamping bar (18), as a result of which the clamping bar (18) comes to completely lie within the tool body (12) and the shaft bodies (14, 16).

4. The hobbing cutter according to claim 1, characterized in that the flange (36) has at least one radial groove (40, 42) which is aligned with a radial groove (30, 32) on an axial collar (26, 28) of the tool body (12).

5. The hobbing cutter according to claim 1, characterized in that the tool body (12) is integrally formed from sintered carbide.
